(19) United States
(12) Patent Application Publication
(10) Pub. No.: US 2003/0123592 A1
(43) Pub. Date: Jul. 3, 2003

(54) Clock and data recovery unit

(76) Inventors: Sean-Paul Woyciehowsky, San Jose, CA (US); Christopher J. Clark, Hermosa Beach, CA (US)

Correspondence Address: PENINSULA IP GROUP, A Professional Law Corporation, 2290 North First Street, Suite 101, San Jose, CA, 95131, US

(21) Appl. No.: 10/033,702

(22) Filed: Dec. 27, 2001

(51) Int. Cl. H04L 7/02

(52) U.S. Cl. 375/359

(57) ABSTRACT

Clock and data recovery apparatus for deriving and dividing a clock signal from data incoming to the clock and data recovery apparatus and for retiming the incoming data and for multiplexing the retimed data to regenerate the incoming data.

### FIELD OF THE INVENTION

The present invention relates to clock and data recovery apparatus and in particular to clock and data recovery apparatus for recovering high speed clock and data signals from high speed incoming information.

### BACKGROUND OF THE INVENTION

High speed digital and optical communication systems are widely installed in many areas of the United States. These types of communication systems generally have transmitter/receiver apparatus and a transmission facility or line interconnecting the transmitter/receiver apparatus to provide a path over which data may be exchanged between the transmitter/receiver apparatus. Increasing advances in technology and the need for more information require greater speed in the rate of transmitting data. The technology has went from analog systems to digital information systems capable of transmitting digital data in the form of logical “0's” and “1's” oftentimes referred to as bits and the combination thereof oftentimes referred to as bytes. In an effort to increase the speed of transmission systems, the technology has advanced to the use of high speed digital data transmission systems using transmitter/receivers interconnected by optical fiber, wave guide, microwave, radio and the like transmission facilities that transmit high speed pulse bit information between the transmitter/receivers.

High speed digital transmitters and receivers are oftentimes connected by long transmission facilities. Typically, a digital transmitter applies binary digital signal data to the transmission facility which is then sent to a receiver designed to receive and decode information contained within the received data. The characteristics of the transmission line often times deforms the waveform of the transmitted data such that the transmitted data is meaningless when it is received by the distant receiver. Thus, long transmission lines oftentimes have regenerator or repeater units that connect the output end of an incoming transmission facility through the regenerator or repeater units to the input end of an output transmission facility. The regenerator or repeater units operate to regenerate the incoming transmission facility data and apply the regenerated data to the outgoing transmission line. At the originating end, a transmitter will receive data and clock signals and modulate the received data and clock signals that are applied as transmission data to an outgoing transmission facility connected to the transmitter. A receiver connected to the output of an incoming transmission facility decodes the received transmission facility data back into the originated data and clock signals.

As the rate of data transmission increases there is a need for apparatus to accommodate the microwave nature of the transmitted data. A problem arises in that it is often difficult to design apparatus that functions properly to handle high speed data required by today's telecommunication systems. Accordingly, a need exists for clock and data extraction apparatus for use in high speed telecommunication systems.

### SUMMARY OF THE INVENTION

It is an object of the invention to provide clock and data recovery apparatus for deriving and dividing a clock signal from data incoming to the clock and data recovery apparatus and for retiming the incoming data and multiplexing the retimed data to regenerate the incoming data for application to an outgoing transmission facility or terminal receiver apparatus.

It is also an object of the invention to provide wave guide filter apparatus for use with clock and data recovery apparatus to derive a clock signal from data incoming to the clock and data recovery apparatus.

It is also an object of the invention to provide a frequency divider for use with clock and data recovery apparatus for dividing a clock signal derived from data incoming to the clock and data recovery apparatus by a factor of two and generating a divided clock signal.

It is also an object of the invention to provide decision apparatus for use with clock and data recovery apparatus to receive incoming data and which is enabled by a derived and divided clock signal to generate data from the incoming data at rates determined by the divided clock signal and for multiplexing the generated data with the derived and divided clock signal to regenerate the incoming data.

It is also an object of the invention to provide non linearity apparatus for use with clock and data recovery apparatus to receive incoming non-return to zero data and generate pesudo return to zero data for application to wave guide filter apparatus to generate a clock signal from the incoming data.

In a preferred embodiment of the invention, clock and data recovery apparatus has apparatus for deriving and dividing a clock signal from data incoming to the clock and data recovery apparatus and decision apparatus which is enabled by the divided clock signal for retiming the incoming data and multiplexing the retimed data with the divided clock signal to regenerate the incoming data.

Also in accordance with an embodiment of the invention, clock and data recovery apparatus has wave guide filter apparatus for deriving a clock signal from data incoming to the clock and data recovery apparatus and a frequency divider for dividing a frequency of the clock signal derived by the wave guide filter apparatus by a factor of two and generating a divided clock signal. Decision apparatus receives the incoming data and is enabled by the generated divided clock signal for generating data from the incoming data at rates determined by the divided clock signal and multiplexes the generated data with the divided clock signal to regenerate the incoming data. A phase shifter connected to the output of the frequency divider is provided to permit shifting the phase of the divided clock signal to time align the decision apparatus.

Also in accordance with the embodiment of the invention, clock and data recovery apparatus for recovering incoming non-return to zero data and regenerating clock and data has non linearity circuitry for generating pseudo return to zero data from the incoming non-return to zero data that is connected to wave guide filter apparatus for deriving a clock signal from the generated pseudo data. A first amplifier coupled with the output of the wave guide filter apparatus amplifies the derived clock signal and applies the amplified clock signal to a frequency divider arranged to divide a frequency of the derived and amplified clock signal by a factor of two and generate a divided clock signal. A second amplifier connected to the frequency divider amplifies the divided clock signal and provides an output of the amplified divided clock signal. A pair of flip-flop circuits doubled triggered by the incoming data and by the divided clock signal and a complimentary of the divided clock signal generate data at a data rate reduced by one-half of the data rate of the incoming data and applies the half-rate data to multiplexer apparatus that is controlled by the divided clock signal for regenerating the incoming data from the reduced rate data. A phase shifter is provided for shifting a phase of the divided clock signal to time align the flip-flop circuits.

### BRIEF DESCRIPTION OF THE DRAWINGS

For a further understanding of the objects and advantages of the present invention, reference should be had to the following detailed description, taken in conjunction with the accompanying drawing figures, in which like parts are given like reference numerals and wherein:

FIG. 1 is a block diagram of clock and data recovery apparatus in accordance with principles of the invention for recovering clock signals and data from incoming non return to zero data transmitted on high speed telecommunication systems,

FIG. 2 is a block diagram of clock and data recovery apparatus in accordance with principles of the invention for recovering clock signals and data from incoming return to zero data transmitted on high speed telecommunication systems,

FIG. 3 is a circuit diagram of the non-linearity apparatus of the non-return to zero clock and data recovery apparatus set forth in FIG. 1, and

FIG. 4 is a block diagram of the decision apparatus set forth in FIGS. 1 and 2.

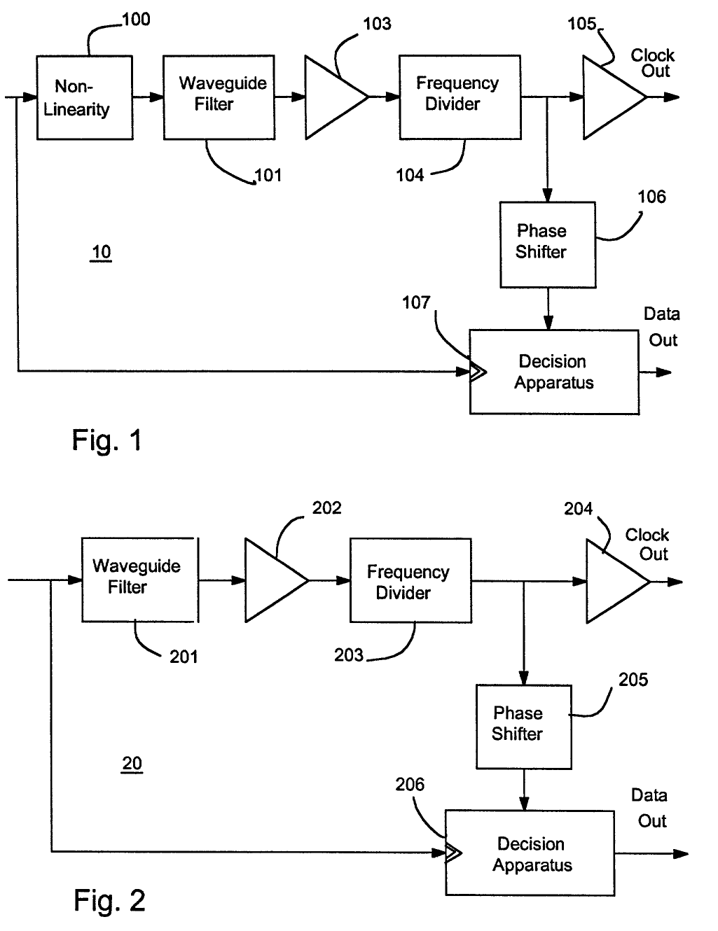

The logic component circuitry of the apparatus set forth in FIGS. 1 through FIG. 4 of the drawing is performed by wave guide apparatus and by solid state and electrical elements, the individual operation of which are well known in the art and the details of which need not be disclosed for an understanding of the invention. Typical examples of these logic circuitry are described in numerous textbooks. For example, such types of logic circuitry, among others, are described by J. Millman and H, Taub in Pulse, Digital and Switching Waveforms, 1965, McGraw-Hall, Inc., H. Alex Romanowitz and Russell E. Puckett in Introduction to Electronics, 1968, John Wiley & Sons, Inc., E. J. Angelo, Jr. in Electronic Circuits, Second Edition, 1958, McGraw Hill, Inc. and in The TTL Data Book for Design Engineers, Second Edition, 1976, Texas Instruments Incorporated.

### DETAILED DESCRIPTION OF THE INVENTION

With particular reference to FIGS. 1 and 2 of the drawing, clock and data recovery apparatus 10 and 20 may be used with high speed data transmission systems to recover clock signals and data. The apparatus 10 and 20 may be used at repeater locations interconnecting incoming transmission facilities with outgoing transmission facilities to recover data and clock signals from data incoming to the repeater location and to regenerate the recovered data for transmission on an outgoing transmission facility. The apparatus may also be used at receiver locations terminating incoming transmission facilities for recovering clock and data from the high speed incoming data so that the recovered clock signals and regenerated data may be used by the data receiving equipment. Clock and data recovery apparatus 10 is used in recovering and regenerating clock signals and data from incoming non-return to zero digital data and clock and data recovery apparatus 20 used for recovering and regenerating clock signal and data from incoming return to zero digital data. Both clock and data recovery apparatus 10 and 20 derive and divide a clock signal from data incoming to the clock and data recovery apparatus and are enabled by the divided clock signal for retiming the incoming data and multiplexing the retimed data to regenerate the incoming data.

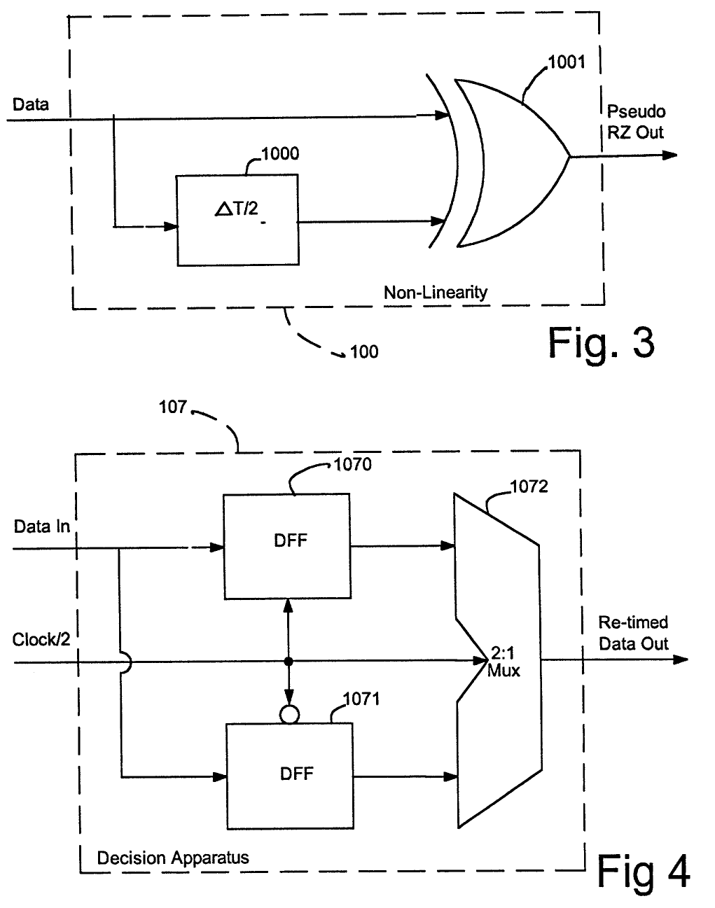

Incoming non-return to zero data, FIG. 1, is applied to non-linearity apparatus 100 of clock and data recovery apparatus 10. The incoming non-return to zero data, FIG. 3, is applied to one input of an exclusive OR logic gate 1001 and to the input of a time delay circuit ΔT/2 1000 which delays the incoming non-return to zero data and applies the delayed data signal to another input of the exclusive OR logic gate 1001. Exclusive OR logic gate 1001 responds in the well known manner to the two input signals by generating pseudo return to zero output data signals having a strong clock tone representative of the clock signal used to generate the non-return to zero data incoming to the clock and data recovery apparatus 10, FIG. 1.

The pseudo return to zero output data generated by non-linearity apparatus 100 is applied to the input of a wave guide filter 101, with a quality factor (Q)>800, to derive a clock signal having generated the incoming data. The derived or recovered clock signal is applied to a first amplifier 103 coupled with the wave guide filter apparatus 101 for amplifying the derived clock signal and applying the amplified clock signal to the input of frequency divider 104. The amplified derived clock signal is divided by a factor of two, although other factors may within the teaching of the invention be designed into the frequency divider 104. The divided frequency clock signal relaxes the stringent tolerances on the design of the circuitry to make the design of clock and data recovery apparatus 10 and 20 more achievable and able to handle higher frequency data. Amplifier 105 connected to the frequency divider 104 amplifies the divided clock signal and provides an output of the amplified divided clock signal from clock and data recovery apparatus 10.

The divided clock signal generated by frequency divider 104 is applied in combination with the incoming non-return to zero data to inputs of the decision apparatus 107. The decision apparatus 107 upon receiving the incoming non-return to zero data is enabled by the divided clock signal to generate data at rates determined by the divided clock signal and multiplexes the generated reduced rate data with the divided clock signal to regenerate the incoming data. Phase shifter 106, connected to the output of frequency divider 104, receives the divided clock signal generated by frequency divider 104 and shifts the phase of the divided clock signal to time align the decision apparatus 107.

Decision apparatus 107, FIG. 4, comprises logic devices 1070, 1071 wherein each is enabled by the incoming non-return to zero data. Logic device 1070 is enabled by the divided clock signal and logic device 1071 is enabled by an inverted or complementary one of the divided clock signal such that each logic device 1070,1071 generates data at a reduced data rate less than the data rate of the incoming data. Multiplexer apparatus 1072 is connected to the pair of logic devices 1070, 1071 to receive the reduced rate data and is controlled by the divided clock signal for regenerating the incoming data as retimed data from the reduced rate data. In an embodiment of the invention, the frequency of the clock signal derived from the incoming data is divided by a factor of two. The logic devices 1070,1071 may be a pair of D-Flip-Flop circuits doubled triggered by the incoming data and enabled by the divided clock signal and a complimentary of the divided clock signal for generating the reduced rate or half rate retiming of the original incoming data stream.

The clock and data recovery apparatus 20, FIG. 2, differs from the data recovery apparatus 10, FIG. 1, in that data recovery apparatus 20 recovers and regenerates retimed data from incoming return to zero data. Incoming return to zero data is applied to wave guide filter apparatus 201 which derives a clock signal therefrom and applies the derived clock signal to a first amplifier 202 to amplify the derived clock signal. Frequency divider 203, having an input connected to the output of amplifier 202, divides the frequency of the derived and amplified the clock signal by a factor of two and generates a divided clock signal that is amplified by a second amplifier to provide a divided clock output signal. Decision apparatus 206 is similar in construction to the decision apparatus 107 of clock and data recovery apparatus 10, FIG. 1, and has a pair of flip-flop circuits 1070, 1071, FIG. 4, doubled triggered by the incoming return to zero data and by the divided clock signal and a complimentary of the divided clock signal for generating reduced rate data at a data rate reduced by one-half of the data rate of the incoming return to zero data. Multiplexer apparatus 1072 connected to the pair of flip-flop devices 1070, 1071 receives the generated reduced rate data and is controlled by the divided clock signal for regenerating the incoming data from the reduced rate data. Phase shifter 205 connected between the frequency divider and the decision apparatus 206 shifts the phase of the divided clock signal to time align the decision apparatus flip-flop circuits 1070 and 1071.

It is obvious from the foregoing that the facility, economy and efficiency of clock and data recovery apparatus is improved by apparatus designed for deriving and dividing a clock signal from data incoming to the clock and data recovery apparatus and for retiming the incoming data and multiplexing the retimed data to regenerate the incoming data. While the foregoing detailed description has described several embodiments of clock and data recovery apparatus for deriving a clock signal and dividing the frequency of the derived clock signal by a factor of two and generating half-rate retimed data that is multiplexed to regenerate the incoming data it is illustrative only and is not limiting of the disclosed invention. Particularly, derived clock signal divided by different factors are within the scope and sprit of this invention. Thus, the invention is to be limited only by the claims set forth below.

What is claimed is:

1. Clock and data recovery apparatus comprising
means for deriving and dividing a clock signal from data incoming to the clock and data recovery apparatus, and
means enabled by the divided clock signal for retiming the incoming data and for multiplexing the retimed data to regenerate the incoming data.

2. The clock and data recovery apparatus set forth in claim 1 wherein the deriving and dividing clock signal means comprises
wave guide filter apparatus for deriving the clock signal from the incoming data.

3. The clock and data recovery apparatus set forth in claim 2 wherein the deriving and dividing clock signal means comprises
an amplifier coupled with the wave guide filter apparatus for amplifying the derived clock signal.

4. The clock and data recovery apparatus set forth in claim 3 wherein the deriving and dividing clock signal means comprises
a frequency divider for dividing a frequency of the derived and amplified clock signal by a factor of two and generating a divided clock signal.

5. The clock and data recovery apparatus set forth in claim 4 wherein the deriving and dividing clock signal means comprises
an amplifier connected to the frequency divider for amplifying the divided clock signal and providing an output of the amplified divided clock signal.

6. The clock and data recovery apparatus set forth in claim 5 wherein the retiming and multiplexing means comprises
decision means receiving the incoming data and enabled by the divided clock signal for generating data from the incoming data at rates determined by the divided clock signal and for multiplexing the generated data with the divided clock signal to regenerate the incoming data.

7. The clock and data recovery apparatus set forth in claim 6 wherein the deriving and dividing clock signal means comprises
a phase shifter for shifting phase of the divided clock signal to time align the decision means.

8. The clock and data recovery apparatus set forth in claim 7 wherein the retiming and multiplexing means comprises
logic devices each enabled by the incoming data and by the divided clock signal and a complimentary of the divided clock signal for generating data at a reduced data rate less than the data rate of the incoming data.

9. The clock and data recovery apparatus set forth in claim 8 wherein the retiming and multiplexing means comprises
multiplexer apparatus connected to the pair of logic devices for receiving the reduced rate data and controlled by the divided clock signal for regenerating the incoming data from the reduced rate data.

10. The clock and data recovery apparatus set forth in claim 9 wherein the retiming and multiplexing logic devices comprises
a pair of flip-flop circuits doubled triggered by the incoming data and enabled by the divided clock signal and a complimentary of the divided clock signal for generating the reduced rate data.

11. The clock and data recovery apparatus set forth in claim 10 wherein the deriving and dividing clock signal means comprises
non linearity means coupled to the wave guide filter apparatus for receiving incoming non-return to zero data and generating pseudo return to zero data for the wave guide filter apparatus.

12. Clock and data recovery apparatus for recovering and regenerating return to zero incoming data comprising
wave guide filter apparatus for deriving a clock signal from the incoming data,
a frequency divider for dividing a frequency of the clock signal derived by the wave guide filter apparatus by a factor of two and generating a divided clock signal,
decision apparatus for receiving the incoming data and enabled by the divided clock signal for generating data from the incoming data at rates determined by the divided clock signal and for multiplexing the generated data with the divided clock signal to regenerate the incoming data, and
a phase shifter for shifting phase of the divided clock signal to time align the decision means.

13. Clock and data recovery apparatus for recovering and regenerating data from incoming non-return to zero data comprising
non linearity circuitry for generating pseudo data from the incoming non-return to zero data,
wave guide filter apparatus for deriving a clock signal from the generated pseudo data,
a frequency divider for dividing a frequency of the clock signal derived by the wave guide filter apparatus by a factor of two and generating a divided clock signal,
decision apparatus for receiving the incoming data and enabled by the divided clock signal for generating data from the incoming data at rates determined by the divided clock signal and for multiplexing the generated data with the divided clock signal to regenerate the incoming data, and
a phase shifter for shifting phase of the divided clock signal to time align the decision means.

14. Clock and data recovery apparatus for recovering and regenerating incoming return to zero data comprising
wave guide filter apparatus for deriving a clock signal from incoming return to zero data,
a first amplifier coupled with the wave guide filter apparatus for amplifying the derived clock signal,
a frequency divider connected with the first amplifier for dividing a frequency of the derived and amplified the clock signal by a factor of two and generating a divided clock signal,
a second amplifier connected to the frequency divider for amplifying the divided clock signal and providing an output of the amplified divided clock signal,
a pair of flip-flop circuits doubled triggered by the incoming data and by the divided clock signal and a complimentary of the divided clock signal for generating data at a data rate reduced by one-half of the data rate of the incoming return to zero data,
multiplexer apparatus connected to the pair of flip-flop devices for receiving the generated reduced rate data and controlled by the divided clock signal for regenerating the return to zero incoming data from the reduced rate data, and
a phase shifter for shifting phase of the divided clock signal to time align the flip-flop circuits.

15. Clock and data recovery apparatus for recovering incoming non-return to zero data and regenerating clock and data comprising
non linearity circuitry for generating pseudo data from the incoming non-return to zero data,
wave guide filter apparatus for deriving a clock signal from the generated pseudo data,
a first amplifier coupled with the wave guide filter apparatus for amplifying the derived clock signal,
a frequency divider with the clock signal amplifier for dividing a frequency of the derived and amplified the clock signal by a factor of two and generating a divided clock signal,
a second amplifier connected to the frequency divider for amplifying the divided clock signal and providing an output of the amplified divided clock signal,
a pair of flip-flop circuits doubled triggered by the incoming data and by the divided clock signal and a complimentary of the divided clock signal for generating data at a data rate reduced by one-half of the data rate of the incoming return to zero data,
multiplexer apparatus connected to the pair of flip-flop devices for receiving the generated reduced rate data and controlled by the divided clock signal for regenerating the incoming data from the reduced rate data, and
a phase shifter for shifting phase of the divided clock signal to time align the flip-flop circuits.
